(19) United States
(12) Patent Application Publication
(10) Pub. No.: US 2008/0161111 A1
(43) Pub. Date: Jul. 3, 2008

(54) Method and System for Interactive Game Playing with Cellular Phones

(76) Inventor: Jason R. Schuman, Layton, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/867,540

(22) Filed: Oct. 4, 2007

Related U.S. Application Data
(60) Provisional application No. 60/828,344, filed on Oct. 5, 2006.

(51) Int. Cl. G06F 17/00

(52) U.S. Cl. 463/41

(57) ABSTRACT

Interactive games such as role playing games are played on a cellular phone. The games are played by transmitting portions of the game to the player and obtaining a response from the player. The game portions are typically transmitted from an internet server and the player's cellular phone, such as their cell phone. Portions of the game may be transmitted as text messages.

### BACKGROUND OF THE INVENTION

1. Related Applications

The present application claims the benefit of U.S. Provisional Application Ser. No. 60/828,344, filed Oct. 5, 2006, which is expressly incorporated herein by reference.

2. The Field of the Invention

The present invention relates to game playing. More specifically, the present invention relates to text based game playing over cellular phones.

3. State of the Art

Many individuals now carry cellular phones (both analog and digital) including those equipped as personal digital assistants (PDAs). As more and more people carry cell phones and PDAs and other portable devices, these devices become more sophisticated and have added functionality. For example, many cell phones include large digital displays, cameras, and some memory for storing images, sounds, programs, etc. Many cell phones or electronic devices are used for entertainment purposes.

Because of the memory and processing capabilities of these devices, people are able to play only simple games on their cell phone or other device. Existing games are downloaded to the cell phone, and are thus limited to the amount of memory available on the phone. Many persons would like to be able to play more challenging and involving games on their cellular phones.

There is thus a need for a method and system allows people to play a greater variety of games on their cellular phones, such as their cell phone, PDA, etc.

### SUMMARY OF THE INVENTION

It is an object of the present invention to provide an improved method and system for playing games on cellular phones.

According to one aspect of the invention, games are played in real time by transmitting sections of a game from an internet server to a person's cellular phone. Each section may contain game information and may require a response from the player.

According to another aspect of the invention, games are played using text messages. The required information is sent to a player as a text message, email, etc. The message would contain relevant information to familiarize the player with the stage of the game and would typically request input from the player. The player would typically progress through the game by responding to these messages or sending messages to an internet server which is hosting the game.

These and other aspects of the present invention are realized in a method and system for interactive game playing with cellular phones as shown and described in the following figure and related description.

### BRIEF DESCRIPTION OF THE DRAWINGS

Various embodiments of the present invention are shown and described in reference to the numbered drawing wherein:

FIG. 1 shows a schematic diagram showing the various types of communications typically used in the present invention.

It will be appreciated that the drawing is illustrative and not limiting of the scope of the invention which is defined by the appended claims. The embodiments shown and discussed accomplish various aspects and objects of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

According to the present invention, text based games are provided to users via cellular phones and PDAs. As used herein, cellular phones includes the variants thereof such as PDA's, web enabled phones, organizers, etc. As many of these portable devices do not have a large amount of memory for storing an entire game, the games are typically transmitted to the device in pieces, typically consisting of some information for the user to read and a question or statement requiring a response from the user. Pieces of the game are transmitted to the cellular phone in pieces small enough for the device to receive, such as a text message of a predetermined maximum character length. A user progresses through the game by responding to the queries and messages sent to the user.

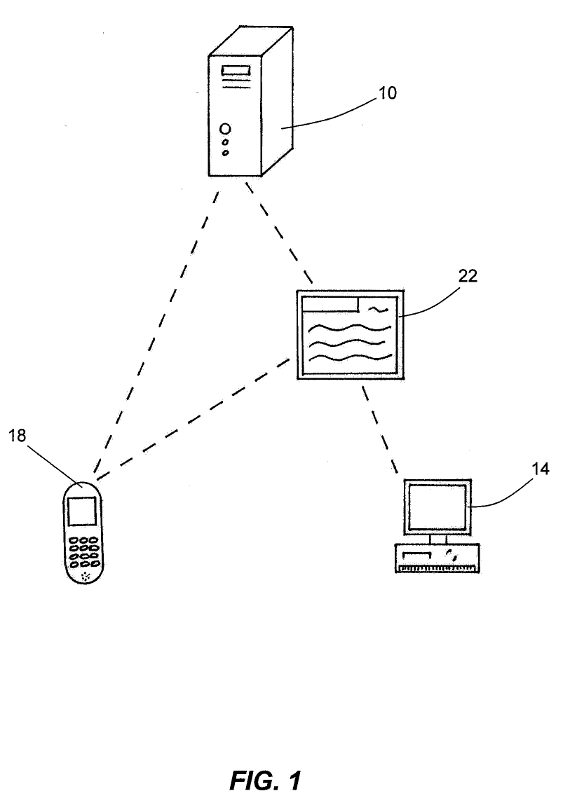

FIG. 1 shows a schematic diagram illustrating some of the various types of equipment and communication utilized in the present invention. In order to facilitate communication with a large number of users, the internet is typically used as a communication medium. A computer 10, typically an internet server, is used to store, transmit, and manage information for the present invention. A user may communicate with the server 10 in different ways, depending on the result the user desires to achieve. For example, if a user desires to register for service, register for a game, check for available games, create a character for a game, pay for service, etc. they would typically use a personal computer 14 to access the server via a web page 22 over the internet. In the alternative, billing may be made to a cell phone 18, such as by authorizing a charge on the user's cell phone bill.

A person would typically use a cell phone 18 or other portable device to participate in the desired games after having registered for the games. It is appreciated that many cell phones 18 and other cellular phones have built in web browsers. Thus, if the device has sufficient web browsing capability, many of the functions which may be handled with a personal computer 14, such as registering for a game or creating a character, may also be performed with the cellular phone.

The website 22 through which a user may access the server 10 would typically include a registration page where a user may sign up for the gaming service, a listing of games which are available, explanations of the games, explanations of how the gaming service works, etc. The website will typically allow a user to create an account, log into the account, and use the account to manage the games which the user is playing, to manage the characters the user has created for those games, etc.

Thus, a person desiring to participate in the games would typically access the server 10 through the website 22 and register for the service. When a user is registering at the website, they will be asked for enough information to validate the identity and age of the user. The information requested would typically be first name, last name, a username or handle, their mailing address, mailing state, and mailing zip code, mailing country, their age to ensure parental consent, etc. The server will also request information such as their home phone number, cellular phone number, cellular phone service carrier, cellular phone make and model, etc. to determine how information is best sent to the user. The website will typically also request personal information such as their interests in gaming and entertainment genre, such as Sci-fi, adventure, old west, foreign countries, rock star, trivia, etc.

The information entered by the user will be stored in a customer file which is associated with that particular user. The customer file will contain the user identification, contact information, and billing information. The customer file will also contain personal information such as gaming interests. The customer file will also be used to store gaming information for the user. The gaming information may include game progress data for a game which the person has started but not finished, points earned, characters which have been created and used in the various games, special game items, prize, or reward information as earned by the person, etc.

The customer file is associated with a unique identification number corresponding to the cellular phone which the customer used in setting up their account. The identification number may typically be the caller identification number (CID). The use of the caller identification number, or another unique device number, assures that only the person in possession of the registered device may access the customer account on the server 10.

The use of the CID allows a person to easily save game data, save points and rewards earned, resume previously started games, etc. as this information is stored in their customer account file. When the person accesses the server 10 via their portable device 18, they may be presented with a variety of options based on their past usage, such as resuming an unfinished game, beginning a new game, redeeming points for additional services or rewards, etc.

Once a user has used the website to register for service and has created their character, if necessary for the desired game, the website will send an authentication key to the desired cellular phone over a selected communication protocol. The communication protocol used would depend on the cellular phone which is used. The user would respond to the authentication key message to finish the process of registering their cellular phone for the gaming service. Example communications protocols are as follows:

SMS: For operating with SMS: 1) the website would call a compiled library function, 2) the library function would then signal the website that an “Authentication Key” was ready to be sent and the authentication key would be placed in the “ready to be sent” message queue, 3) at specific intervals, via schedule jobs, the website application would then read the messages in the queue and send them through the service layer, 4) the service layer would determine how to communicate through SMS and connect to a partner's web API (application protocol interface) accordingly, 5) once the message was successfully transmitted, the library function would end by writing the message, current date, current time, participant ID, insertion node ID (from which website application the participant registered at), and an expiration date/expiration time of this key.

TCP/IP: For operating with TCP/IP: 1) the website would call a compiled library function, 2) the library function would then signal the website that an “Authentication Key” was ready to be sent and the authentication key message would be placed in the “ready to be sent” message queue, 3) at specific intervals, via scheduled jobs, the website application would then read the messages in the queue and send them to the service layer, 4) the service layer would communicate through TCP/IP over the internal network and through the internet, 5) once the message was successfully transmitted, the library function would end by writing the message, current date, current time, participant ID, insertion node ID (from which website application the participant registered at), and an expiration date/expiration time of this key.

E-mail: For operating with e-mail: 1) the website would call a compiled library function, 2) the library function would then signal the website than an “Authentication Key” was ready to be sent and the authentication key would be placed in the “ready to be sent” message queue, 3) at specific intervals, via scheduled jobs, the website application would then read the messages in the queue and send them through the service layer, 4) the service layer would pick up the message and distribute through the SMTP mail protocol over the internet communication line to the destination address, 5) once the message was successfully transmitted, the library function would end by writing the message, current date, current time, participant ID, insertion node ID (from which website application the participant registered at), and an expiration date/expiration time of this key.

Once sent to a user, the authentication key would typically have a “time to live” of 24 hours, after which the authentication key would no longer be valid. After the 24 hours, the participant would then have to request a re-transmittal of the authentication key.

The authentication key may typically consist of a series of random numbers generated by the website application, similar to that of a PIN (“Personal Identification Number”) you would receive from a bank, coupled with a random amount of alphanumeric letters also selected at random.

Once the authentication key is received by the cellular phone, the participant may re-enter it into the website application to complete the cellular phone setup.

Limits or restrictions may be used in combination with the authentication keys to conserve resources or otherwise safeguard the server. For example, the authentication key may be requested a maximum of 5 times before the website application would deem this cellular phone non-valid.

Based on the information given while a participant is registering and setting up their cellular phone, the optimal message size that could be sent to their cellular phone may be determined. For instance, if the device was a Nokia 6100 wireless phone, it would be known that this phone would not only accept a standard SMS text message, but also an MMS message. The length of a single SMS text message could be as large as 250 characters. The story, duel, or game would then be delivered to this cellular phone at 250 character pieces.

If the device was a Blackberry 7100, it would accept the standard SMS text message and email. This phone would also be able to surf websites with its built-in web browser, allowing a person to access the game website via their cellular phone. Thus, the user could create characters, view available games, etc. from the cellular phone. The length of a single SMS text message for a blackberry 7100 mobile phone could be as much as 400 characters. The game or story would then be delivered on this device in a maximum of 400 character pieces. In addition, larger streams of text could be delivered through the WAP protocol if desired.

The WAP protocol (Wireless Application Protocol) is the de-facto world wide standard in delivering wireless information and telephone services on a mobile cellular phone such as a cell phone or PDA. WAP, being a communication protocol, uses the mark-up language of WML (Wireless Mobile Language) and can also interpret a reduced version of JavaScript called WMLScript. WAP was specifically designed for micro-browsers such as the wireless mobile phone or PDA, and can utilize most wireless networks such as CDPD, CDMA, PDC, PHS, FLEX, GSM, TDMA, iDEN, Mobitext, and DECT.

If the device was a T-Mobile Sidekick, the phone would not only accept standard SMS and MMS, but also has e-mail capabilities. This phone would also be able to surf websites with its built-in web browser. The length of a single email message for a t-mobile sidekick is much larger than of SMS, and thus the story could unfold faster for the participant if delivered via email to the telephone instead of via text messages. The story could then be delivered to this device without character restrictions as in the previous devices.

Thus, the various types of devices available have differing capabilities and would allow the games to be delivered to the device in different methods. A user with a cellular phone capable of receiving messages in multiple formats could choose how the messages would be sent. If the person chose to receive the messages via email, they would receive the appropriate game portion, such as a trivia question or story segment, and would respond appropriately by sending their response in an email.

Messages are also sent to the user in accordance with the particular game which is played. For example, trivia games may have relatively short messages presenting a trivia question and requiring an answer. Role playing games may have longer messages which describe a situation, including the scenery around the character, the location, items in the location, enemies in the location, etc. The messages will also typically present questions to the player to determine how the player wishes to proceed. The player could respond to the questions, and could also explore the location by looking at items or otherwise interacting with the items around the character. Such actions would be sent as messages to the server. The messages sent to the user may be divided into multiple smaller messages if the message is too large to be received at once.

Once the cellular phone has been setup, the participant can then select the type of story or game they wish to play or interact with. Various types of games may require the participant to select and register for the game via the internet by using a personal computer or other device with similar capabilities. Such games may include role playing games, where a user may need to create a character before playing the game. Thus, some cellular phones which are capable of browsing the internet may have sufficient capabilities to create a character, while other devices may not have sufficient capabilities and would thus require a user to create a character via a computer. Some games may not require previous registration via the internet. Such games may include trivia games or similar games where extensive setup such as creating a character is not required.

It is possible to play many different types of games in a text based format on a portable electronic device. Games may include adventure games, dueling games, role playing games, trivia games, game show type games, etc.

The website may present to a user an environment for selecting games which is in harmony with the aspect of the games being played. For example, a person desirous to play a game may go to the website to register. Once at the website, a user may select a type of game which they desire to play. The type of game may be a western adventure, role playing game, trivia game, etc. They may then be directed to a webpage which resembles the category or type of game they have selected. For example, a user who selected a western adventure may be directed to a webpage which resembles an old-west town, and may move between the various buildings and locations in and around the town to explore and select the various adventures which are available. Similarly, a user who has selected a fantasy role playing game may be directed to a webpage designed as an old map which they can inspect to decide on a particular adventure to take. The adventures may be places on the map with descriptions of the adventure. Alternatively, the webpage could resemble a medieval castle, city, etc. and could allow the user to explore the areas in the location to select a game or quest.

The different types of games which are possible may involve differing interaction between the online server and game host and the user. For example, a role playing game may present many choices to a user, both in initial setup and in play. Such a game may have many character choices, such as human, swordsman, elf, dwarf, wizard, shape shifter, etc. In setting up a character and starting a game, a user may desire to log onto a website to interface with the server. Once the user has verified their identity by logging on, they could create a character.

The user may be allowed to not only choose a character, but may select various attributes for the character. Selectable attributes may be those which affect game play, such as strength or dexterity, or may be cosmetic attributes only. The user may also learn about the game, including challenges presented during the game. Users may also purchase goods and equipment to arm their character. Typically, a user would be allowed to save their character. The progress of the character in the game could also be saved, saving the experience, money, etc. collected while playing.

As a character which the player has created and used in games is developed, i.e. strengthened or otherwise altered through experiences and upgrades, the appearance of the character may change. Such may be reflected in the image of the character as stored on the website or downloaded to the user's cellular phone. Additionally, different types of characters may have different background music corresponding to the character. The music may be downloaded to the person's cellular phone and played as desired or while the person is playing a game with that character. The music could change as the character is developed, and could be made to reflect the status of the character.

The game itself would contain standard aspects of a typical role playing game. Thus, the game would include a variety of foes which would be encountered by the game player, weapons, treasures, a terrain in which the game is played, etc. These elements are presented to the user as text descriptions as the game is played.

Once a character is ready to begin a game, the user would use their cellular phone, such as their cell phone, to access the server and begin a game. The user would typically send their user ID as a text message to the website hosted as the gaming interface. The user would then be welcomed and asked if they would like to begin a new game or play a game already in progress. The user's progress in previous games may be saved on the server to allow the user to continue the game when desired.

Many aspects of the character which a person has created for a game, such as type of hair, facial features, armor, magic potions, clothes, shoes, weaponry, knowledge, skill, endurance, stamina, could be selected when creating a character or purchased prior to beginning a game or entering a segment of the game. Some character features could come as a natural enhancement over time and in response to a correctly chosen path or correct answers to trivia questions posed during the interactive story or game. Thus, a character would gain strength, experience, skill, etc. during game play.

Some of the more advanced items or attributes could be earned at special points during game play or be upgraded outside of the game play. Thus, a person who has reached a certain point in a game may have the opportunity for training or purchasing additional equipment or supplies. The person may need to have collected certain items during the game to receive the desired upgrades. Alternatively, a person may acquire upgrades outside of the game play. After completing a game or portion of a game, the person may return to a training center or armory to acquire upgrades. The person may engage in learning sessions or purchase equipment or supplies. Some items may be purchased as a subscription upgrade.

The participant can optionally save their character, such as in their ‘digital locker’ and use the character in a game or story some time in the future. Not all characters would be usable in all game or story types. A participant choosing a game or story type similar to one previously played could use their saved character from the previous game.

The participant can save a ‘photo’ of their character for download to their cellular phone or send a ‘photo’ of their character to other players' cellular phones, such as to others participating in a group game.

The user, or player, starts the game with one character. This character could be previously created as discussed. Alternatively, the user could create a character via their cell phone by proceeding through a series of questions regarding character attributes. This would allow a user to begin a new game at any time without needing web access.

The role playing and adventure games could also allow multiple players to play a single game. The server would track the location of the various players in the game, whether together or separated, and would track the items accumulated by the players, the movements, and accomplishments of the players.

A player resuming a previous game would be presented with text messages relevant to that point in the game. A player starting a new game would be introduced into a particular adventure via text messages and would make decisions and progress through the game by sending and receiving text messages from the server. Multiple players may send text messages to each other to collaborate in game play.

During a game or story, the participant would typically be asked trivia type questions or action type questions with the opportunity to advance if answered correctly. Trivia questions would require the participant to show knowledge about the situation presented in the game. Action type questions may simply require the player to decide which direction to go, whether to engage in combat, etc.

Where a single person is playing a game or story, the person would be asked a question regarding the story or regarding a characteristic of some object encountered in the story. This question would be delivered to their cellular phone as discussed. The participant would need to have either an understanding of the story plot or challenge, or may be required to research on the game website for the answer, or ask for a hint from the system. If the answer given was correct, the participant would earn points, progress, or defeat their opponent, depending on the storyline.

If a group of persons were participating together in a game or story, a token or indicator could be used to determine which participant is required to respond to the situation. Alternatively, a particular type of character may be required to respond to a particular challenge, or characters might be chosen at random to respond to a challenge. Some challenges may require two or more players to both respond to the same or different aspects of the challenge.

When a situation arises which requires the participants to take action or choose a path for the interactive story, the participant who is required to respond to the challenge may be able to either take the turn for the group or pass the challenge to another player. Once it is decided who will respond, that participant would be asked a question regarding the story or characteristic. This question would be delivered to their cellular phone. The participant would either have to have an understanding of the story plot, research on the website application for the answer, or ask for a hint from the system. If the answer given was correct, the participant would earn points or defeat their opponent, depending on the storyline.

As an example of how a role playing game might proceed, a person starting a new game might be presented with a text message on their cell phone containing the following:
Horatio your guide leads you into the darkness. With only torches to light your way the creepiness of the dungeon even seems more ominous. Horatio informs you that this is as far as he can take you. There is danger up ahead and he is not being paid enough to risk his neck. You thank him politely and he walks back the way you came. Suddenly you hear him cry out and his torch is extinguished You spin around and run back to where you last saw him. He is lying on the ground with a huge spider on his chest. As the spider turns its attention from Horatio to you . . .

Such a message familiarizes the user with the current game situation. The player would then be required to respond to the situation. The same or a new text message sent to the player might include:
You decide to:
A: Run away from Horatio and the spider and continue your adventure further.
B: Try to kill the spider with your sword.
C: Try to scare the spider off Horatio with your torch.

The player would typically choose a response by sending a reply text message. For example, the player could choose choice C by replying to the text message or sending a new message containing the letter C. The player would then be sent another text message describing the outcome of the situation.
The spider hisses at you as it slowly backs away from your flaming torch. Venom drips from it's fangs as its many eyes search for a way around the flames so it can sink the fangs into your tasty flesh. You continue to thrust the torch into the spiders face as it backs away. What can you use to keep this spider away permanently?
(Hint) On G-Texing com you can read about spiders in Orion 's Gate.

The more a player knows about the foes, the greater chance that they will survive and increase their strength and experience points. Thus, a player may spend time researching the various difficulties which will be presented during the game. The player may also be provided with hints for resolving a problem presented in the game. The hints may direct the player to a website or resource for finding the correct solution for the problem. From previous research, the player may know that spiders are kept away with cat urine. The player may also have purchased some at the armory in the beginning of your adventure.

The player may thus respond to the situation by sending a response text:
Cat urine.

The player may receive a text message reading:
What will you do with it?

The player might then send a text message:
Spray it on the ground between you and the spider.

The player will then receive a text message indicating whether the response is correct. Correct responses may gain the player experience points or strength points, or may also gain treasures or supplies carried by the enemy. If a player responds incorrectly, the player may be attacked by an enemy or be harmed from the situation. Thus, the player may lose health or even possessions. The player would receive a text message indicating the outcome.

The game would continue on in this way until the character is killed or the adventure is completed. The player could start over where they left off or restart the adventure where they made a poor decision.

A player which has been killed may lose experience, strength, magic points, etc. and have to rebuild them. A player may decide to purchase additional supplies, etc. via the website (such as at an armory) before beginning or resuming a game. A player may also purchase the relevant game currency with a pay pal account or credit card for a minimal charge.

After a player has completed an adventure they can save their character for future games along with all their points, armor, weapons, and magic, etc. As discussed above, all aspects of game play are accomplished by text messages or the like sent between the player and the server hosting the game. Many different types of games will function in the manner discussed above, including adventure games, dueling games, role playing games, story based games, etc.

Another example of the games that can be played via text messaging on cellular phones is the duel, fight, or war between two or more players, i.e. a dueling game. Typically, the participants would create a character that would be used in their games using the character creation program on the hosting computer as described above. The participants will be able to create a visual representation of their character using custom templates that they select to make their character unique. The participants may be able to select the type of character, attributes of their character, weapons or abilities of their character, etc.

Once a person has completed their character and is ready to begin the duel game, they would be able to send their character as a graphic to their cellular phone or phone via MMS where the player could then save the graphic on their phone or send it on to a friend. Their character could be updated at any time through the website. After their character is created they will be able to sign up to play the dueling game.

The communications protocol for players to participate in the dueling game, as well as the other games, would typically be SMS. The computer server providing the gaming service may utilize MMS or WAP communication to send messages to the user in an effort to provide more lengthy information, graphics, or sound to the user. The MMS communication to a player can consist of graphics, images, photos, sound, and text.

The WAP communication to a player can consist of graphics, images, photos, sound, and text, in a larger format which is similar to a web page without communicating over the internet. The communication is done thru the internet via the WAP protocol, thus not invoking “internet usage time” for many mobile devices.

The duel game is played by one player challenging another player to a fight or duel, and the other player accepting. The player that issues the challenge attacks first using magic or weapons. The attack can be simple as a sword strike or as complex as multi layered magic spells. The player being attacked will use a defense against the attack. If the attack is “sword strike” the defense would be “shield block” or if it was a magic attack the defense would comprise of specific protective spells for each magic attack sent. The game engine would calculate the amount of damage that got through the defenses of the attacked player based on the choice of defenses for the particular attacks, the skill level of the player, etc. Each player would start with a set number of health points, and game points. Game points are earned either through experience of dueling or can be recharged on the website though various methods to expose the player to advertising from the sponsors.

As damage from each attack is calculated a number of points will be deducted from the defenders health points until the points reach zero or the opponent retreats (forfeits) from the duel. When one players health reaches zero (or the opponent has quit) the duel has ended. The winning player receives a number of game points from the opposing player. This will be on a handicap scale based on the level each player is at. Two players with equal skill levels would give the victor more game points that a player would receive if he defeated someone that is of a lower skill level.

Thus, an example of the dueling game may be as follows:

To begin a duel game, a user would “challenge” another player either through the website or from their cellular phone. The user being challenged, would receive an SMS text regarding the challenge, asking if they accept the challenge. The challenged user would reply with “accept” or “decline”, which would communicate to the server, and on to the original challenger. If accepted, they would both engage in a 1 on 1 duel challenge over the specified protocol.

The game play scenario of the duel would typically be as follows: User A would begin the duel or challenge by inviting another person such as a friend over the phone or through the website. The server would already know how to communicate with this other user (User B), since they too would have already completed the user registration in order to be eligible for game play.

User B would then receive the text message: “You are being challenged to a duel, by the user “USER A”.

DO YOU ACCEPT?

Reply with Y or N”

User B would reply, via SMS, “Y”.

User A would then receive an SMS message “Your challenge has been accepted by User B. Prepare to square off.” User B would also receive a message “Prepare to square off”.

User A could send the SMS text “ATTACK MODE”

The server would reply with “You have entered Attack Mode.” Attack mode would enable the users keywords to automatically begin with the word “ATTACK”, so this becomes a shorthand while you are in battle. Thus, instead of ATTACK AXE the user can just send a text message with the word AXE or PUNCH and the system will properly interpret the command from just the one word.

Each user would be allowed to submit one attack and one defense per turn. Typically, any one user would not have the ability to send two attacks at a time, no matter how fast they sent their SMS text to the server.

Thus, game play may proceed as follows:

User A sends the SMS text:

STUPIFY

(Since User A is in attack mode shorthand, this would be interpreted as “ATTACK STUPIFY”)

User B would then receive the SMS Text:

“User A is trying to attack with STUPIFY.”

User B sends the SMS text: “ATTACK PROTECTO” to the server.

User B would then see the SMS text:

“You blocked the STUPFIY attack!”

User A would see the SMS text:

“User B blocked your attack with a PROTECTO spell!”

The game play would similarly continue until either one of the users health became zero, or one of the users quit and forfeited this challenge.

Game points which are won or earned can be redeemed for prizes. If a player has amassed game points, they could redeem them for prizes such as a video game from a prize store accessed on the main gaming website. The prize store will include multiple prizes from small prizes which are easily attainable to grand prizes that will take some time to achieve.

If a player loses all their game point they may recharge them for a fee via the main gaming website, or they can play some fun simple games or engage in interactive advertisements that exposes them to sponsors products or services. Each activity, game, or commercial they participate in will earn them game points that they can use to continue dueling or playing other games. As such, revenue may be generated from the companies who are advertising on the hosting website, and the players may gain game points and gain access to the various games by viewing the advertisements. Such is advantageous as it allows the players to gain game points for free, and as it requires the players actually view the advertisements.

The dueling game may also allow multiple players to join together on teams and play other teams of players or other single players. Players may also choose to attack a computer generated and controlled character. Dueling against computer generated and controlled characters can be used to hone skills and practice before attacking other players.

The main web site for the dueling games will typically consist of an information page, a sign up page, a game points page where players may purchase or acquire points, a magical education page, game rules, a point store page where players may redeem points for prizes, sponsor links, and online dueling.

Other types of games available for a user would typically include trivia games. Trivia games could function in a variety of ways. A user could play a trivia game against a group of friends or alone. After selecting the type of game to be played and including all desired players in the game, the server would send text messages to the players which included the questions or puzzles to be solved. The message could also include hints or answer choices as may be appropriate to each question. The players may respond to the questions by sending a text message, email, etc. to the server. The game may be set up to only allow one response from a particular player for each question. Where there are multiple players, the first to answer correctly would be the winner for that question. For a single player, a time limit may be imposed for answering the question.

Trivia type games could also be played with a number of unacquainted persons. The user would typically sign up to receive notice of a trivia game that would be played on a certain date and time in the future. The participant would typically be informed of the length of the game. Typically, multiple categories of questions would be offered. These games would typically be timed events. The winner may be the person with the most points accumulated, which may be determined in a variety of ways. For example, only the first to respond may get points for a question. Alternatively, points may be given based on the correct answer and the time to enter the correct answer. Additionally, multiple persons may be given points for the question, based on a correct response and the time required for the answer. Thus, the participant with the most points will win. The winner may receive prizes such as cash and prices donated by sponsors. Trivia games will typically be announced on the website, and will typically include sponsor banners and sponsor information so as to induce game sponsors.

Many different category types of trivia games could be offered, such as Popular Music, Video Games, Movie Lines, Cool Cars, Fashion Trends, and so on.

Thus, when users are participating in a trivia game, text messages would be sent to the cell phones or other cellular phones of the participants. The messages could include open ended questions, true false questions, multiple choice questions, etc. Where a single person is playing the trivia game, they may have a limited time to answer the question, or may be timed to determine how long it took them to provide an answer. After the person gives an answer by sending a text message back to the server, they may receive a text message indicating whether they were right or wrong, and indicating the correct answer. The person may also be able to skip the question if desired, and may be sent a text message indicating the correct answer if they do not answer within an allotted time or skip the question.

Users could win prizes for participating in trivia games. The questions in a trivia game could be directed towards a particular company or product which is sponsoring the trivia game and the winner could win a prize from the sponsoring company. Additionally, persons could win points which they could use in entering additional games, purchasing supplies for a character used in a game, etc. Points may be given to the top individuals, or to all individuals according to their score in the trivia game.

It is thus anticipated that a user would maintain an account which would store relevant information related to their game playing. As has been discussed, a user could store characters created for the various games and could store the attributes, supplies, etc. carried by those characters. A user could also store the results of the various games which they have played, including points or prizes which may be used to upgrade a character in a game or start new games.

Users could also play interactive games such as scavenger hunts. One type of scavenger hunt would combine web surfing with sending text messages with their cellular phone. The cellular phone would be used to send their answers back to the host server. Typically, the participant would have to go online to find items or pieces of information required by the scavenger hunt game. Items may be selected from games sponsor's products or services, requiring the participant to study the sponsor's web sites, looking for clues.

The game may progress by sending text messages to the participant's cell phone or other cellular phone. The participant would have to search for the requested piece of information. The text message sent to the participant may direct them to a particular company or website, or may just provide clues about the requested piece of information. The participant would decipher the clues and search for the requested product. Once the participant finds the information, they would send a text message to the server with the information. If the information sent is correct, the participant would typically receive another text message containing the clues for the next item to be found in the hunt. If the information is incorrect, the user will typically receive a text message that the answer was incorrect, and that they should keep looking. The first participant to complete the scavenge hunt may win cash and prices donated by our sponsors, points usable in playing other games, etc.

As an example of game play, participants may be sent a message such as:
“This is a place of refuge when aliens are attacking you.”

The participant would then login and surf the sponsor's websites and reply via their cellular phone the answer:
“Sanctuary from xbox.com in game Halo 2”

A correct answer would cause the participant to receive the next clue from the server.

Many different types of games would allow multiple participants to play the game together as a group. In such a situation, the participant beginning a game would select the desired game and then must then select the total number of participants in the game. The primary participant could select friends to play the game with them, and could send a text message to the server with information to identify the persons, such as their logon identification. The server would typically then send a text message to those persons inviting them to join the game. The game could then begin with those participants who chose to join the game.

During the game, the participants would typically be able to communicate with each other. They might typically communicate with each other by sending text messages to each other. In such a manner, the participants could help each other in the game by providing information.

Where only one person is playing a game, the game or story would be communicated to only that one participant, back and forth between the server, typically via a website, and the participant's cellular phone.

Where multiple persons are participating in a game together, various methods could be used to control the game play. Each participant could have a chance to play when the “token” was given to them, when picked by the primary player, in sequential order, in random order, according to when each participant joined the adventure, etc.

In some games, it is anticipated that multiple players will progress together through the game as a group. Accordingly, multiple players may have an opportunity to respond to a challenge presented in the game. Players may also have the ability to exchange items that they are carrying, etc.

Additionally, in some games the group of cooperating players may become separated. In such a situation, individual players or groups of players may separately play through a smaller portion of the game, and may possibly become reunited with the group after completing the separate portions of the game.

According to one aspect of the invention, a person may, at any time desired, visit the website to view their own status. When a person has logged into the website, they would typically be able to view the total time they have invested in an interactive story, view the characters they have created and used in stories, view the points or game items they may have accumulated, view the various games that they have completed, etc. For persons playing a group type game, they could see the time for entire group as well as all individual characters, and could see how many times each character answered correctly, incorrectly, or passed the token to the next player, if applicable to the game. Another feature which could be viewed by persons logged into the website is the high score board for the games which they have played.

Persons visiting the website may be able to see the various types of games available, the games which are scheduled in the future, etc. Visitors to the website could also see details of service and information about registering for service and registering for available and upcoming games.

By recording a person's progress through a game, a person could stop playing a game at a desired point and resume play later. Through the use of the authentication key, story adventure can always begin where the participant was last. Alternatively, a player could choose to begin a different story. The person's progress through games and partially completed games could be saved on the server for a designated period of time, allowing a person to play a different game, such as a scheduled trivia game, while saving progress in a longer role playing game and continuing play later.

During a game or story, the participant can elect to end the game and stop play. If the participant ends a game or story at will, then the character, along with any character upgrades or purchases would typically be lost and not saved for future use.

There is thus disclosed an improved method and system for interactive game playing using cellular phones. It will be appreciated that numerous changes may be made to the present invention without departing from the scope of the claims.

What is claimed is:

1. A method of playing a game comprising:
a first customer accessing a host computer via a website, the host computer having a plurality of text based games stored thereon;
the first customer creating a first customer account on the host computer via the website, the first customer account including the telephone number and device information for a first cellular phone;
the host computer storing the first customer account;
the first customer selecting a game from the plurality of text based games via the website;
the first customer signing up for the game via the website;
the first customer using the first cellular phone for communicating with the host computer to play the selected game;
the host computer transmitting a portion of the game to the first cellular phone;
the first customer reading said portion of the game;
the first customer responding to the portion of the game by transmitting a text response from the first cellular phone to the host computer.

2. The method of claim 1, wherein the first customer account includes the caller identification number associated with the first cellular phone.

3. The method of claim 2, wherein the caller identification number is used to identify the first customer when the first customer contacts the host computer with the first cellular phone to play a game.

4. The method of claim 1, wherein the first customer creates a character for use in playing the game.

5. The method of claim 1, the method further comprising:
a second customer accessing the host computer via the website;
the second customer creating a second customer account on the host computer via the website, the second customer account including the telephone number and device information for a second cellular phone;
the host computer storing the second customer account;
the second customer selecting the game from the plurality of text based games via the website; and
the second customer signing up for the game via the website.

6. The method of claim 5, the method further comprising:
the first customer inviting the second customer to play a game together by transmitting a message from the first cellular phone to the second cellular phone via the host computer.

7. The method of claim 6, wherein the game play comprises the steps of: the host computer transmitting a portion of the game to both the first cellular phone and the second cellular phone at the same time;
the first customer and the second customer sending responses to the host computer via the first cellular phone and the second cellular phone;
the host computer receiving responses from both the first cellular phone and the second cellular phone; and
the host computer crediting as correct the customer who first provided the correct response to the host computer via a cellular phone.

8. The method of claim 6, wherein the game play comprises the steps of:
the first customer transmitting first commands from the first cellular phone to the second cellular phone via the host computer;
the second customer transmitting a response to the first commands and second commands from the second cellular phone to the first cellular phone via the host computer.

9. The method of claim 4, wherein the method further comprises:
the first customer acquiring points while playing a game and using the points to purchase upgrades for the character.

10. The method of claim 1, wherein the method further comprises:
the first customer viewing sponsor advertisements via the website to earn points and using the points to play games via the host computer.

11. A method of playing a game comprising:
transmitting a game scenario and a request for player input from a host computer to a cellular phone;
a game player viewing the game scenario and request for a first player input on the cellular phone;
the game player transmitting input from the cellular phone to the host computer;
transmitting a new game scenario and a request for input from the host computer to the cellular phone, the new game scenario being based on the first player input provided from the player.

12. The method of claim 11, further comprising the game player creating a customer account on the host computer, the customer account having the caller identification number for the first cellular phone stored therein, and wherein the host computer automatically associates messages from the game player with the customer account based on the caller identification number.

13. The method of claim 12, wherein the method comprises transmitting the game scenarios, requests for input, and player input as text messages.

14. The method of claim 11, wherein the method further comprises:
the game player accessing the host computer via a website and creating a customer account on the host computer;
the game player entering information about the cellular phone into the customer account, the information being sufficient to identify the message transmission and reception capabilities of the cellular phone and to identify the cellular phone with a unique identification number;
the host computer storing the customer account; and
the host computer using the unique identification number of the cellular phone to associate messages transmitted from the cellular phone to the host computer with the customer account.

15. A method of playing a game comprising:
a customer using a cellular phone to communicate with a host computer;
the customer selecting a text based game to play from a plurality of text based games stored on the host computer;
the host computer transmitting a first textual game scenario corresponding to the selected game to the cellular phone;
the customer transmitting a response to the first game scenario from the cellular phone to the host computer; and
the host computer transmitting a second textual game scenario to the cellular phone, the second game scenario being determined at least in part from the response to the first game scenario received from the cellular phone.

16. The method of claim 15, wherein the cellular phone comprises a cell phone.

17. The method of claim 15, wherein the game scenarios and responses are transmitted between the cellular phone and the host computer as text messages.

18. The method of claim 15, wherein the method further comprises:
the customer accessing the host computer via a website;
the customer creating a customer account on the host computer, the customer account comprising information regarding the communication capabilities of the cellular phone and a unique identification number corresponding to the cellular phone; and
the host computer storing said customer account.
